(19) United States
(12) Patent Application Publication
(10) Pub. No.: US 2004/0148062 A1
(43) Pub. Date: Jul. 29, 2004

(54) Driver information system

(76) Inventor: Michael Franke, Hameln (DE)

Correspondence Address: KENYON & KENYON, ONE BROADWAY, NEW YORK, NY, 10004, US

(21) Appl. No.: 10/722,877

(22) Filed: Nov. 26, 2003

(30) Foreign Application Priority Data
Nov. 28, 2002 (DE) 10255435.8

(51) Int. Cl. G06F 17/00

(52) U.S. Cl. 701/1; 701/200

(57) ABSTRACT

A driver information system for a motor vehicle having an operator control for operating the driver information system, a device for detecting travel of the motor vehicle, and a control for limiting and/or preventing an operation of the driver information system via the operator control in the case that motor vehicle travel is recognized, in which a device for detecting the occupancy of a passenger seat of the vehicle is provided, and the control is designed to at least partially cancel the limitation and/or prevent the operation of the driver information system. A driver information system advantageously makes use of a signal that is available in many vehicles and indicates the occupancy of a passenger seat, in order to influence a speed-lock function of the driver information system and, thus, also during vehicle travel, to render possible an operation of the driver information system to a full extent or to an extent that is at least expanded as compared to the speed-lock function. At the same time, the advantages of the speed-lock function, namely that the driver is distracted to a lesser degree by the operation of the vehicle information system, are retained, so that the result is better concentration on the actual driving task and, ultimately, improved traffic safety.

### BACKGROUND INFORMATION

Driver information systems are known in the form of vehicle navigation systems which output driving-direction information in acoustic and/or optical form to guide the driver of a vehicle along a previously calculated route to a destination. In order for the route to be calculated, the driver must first input the destination via an operator interface of the vehicle navigation system. Since inputting a destination while driving substantially distracts a driver from the traffic situation, it has been and is currently being discussed to prevent operation of the device, in particular to prevent the destination from being input during vehicle travel (so-called speed-lock function).

Many of today's vehicles make use of a signal that indicates passenger seat occupancy, which is used, for example, for an airbag control.

### SUMMARY OF THE INVENTION

A driver information system according to the present invention advantageously makes use of a signal that is available in many vehicles and indicates the occupancy of a passenger seat, in order to influence a speed-lock function of the driver information system and, thus, also during vehicle travel, to render possible an operation of the driver information system to a full extent or to an extent that is at least expanded as compared to the speed-lock function. At the same time, the advantages of the speed-lock function, namely that the driver is distracted to a lesser degree by the operation of the vehicle information system, are retained, so that the result is better concentration on the actual driving task and, ultimately, improved traffic safety (safety while driving). In connection with the present invention, operation is understood to be the user's inputs into the driver information system and/or outputs of the driver information system to the user.

Thus, in the case of a navigation system, the front-seat passenger can take over operation of the navigation system during travel. For example, the need may arise during vehicle travel to manually change the driving route because of traffic disturbances not considered in a preceding route calculation or because of errors in the navigation data material.

In this way, during vehicle trips where there is a passenger, additional inputs may be made and unnecessary stops avoided. Safety arguments are likewise overcome. Also, within the framework of the speed-lock function, the present invention also permits a more advanced restriction of the operational control, where necessary, during operation without a passenger.

In any case, the present invention increases user acceptance of the speed-lock function and ensures a competitive advantage.

### BRIEF DESCRIPTION OF THE DRAWINGS

FIG. 1 shows a block diagram of the part of a driver information system according to the present invention that is important to the present invention.

FIG. 2 is a flow chart of the part of a control software that runs in a control of the driver information system.

### DETAILED DESCRIPTION

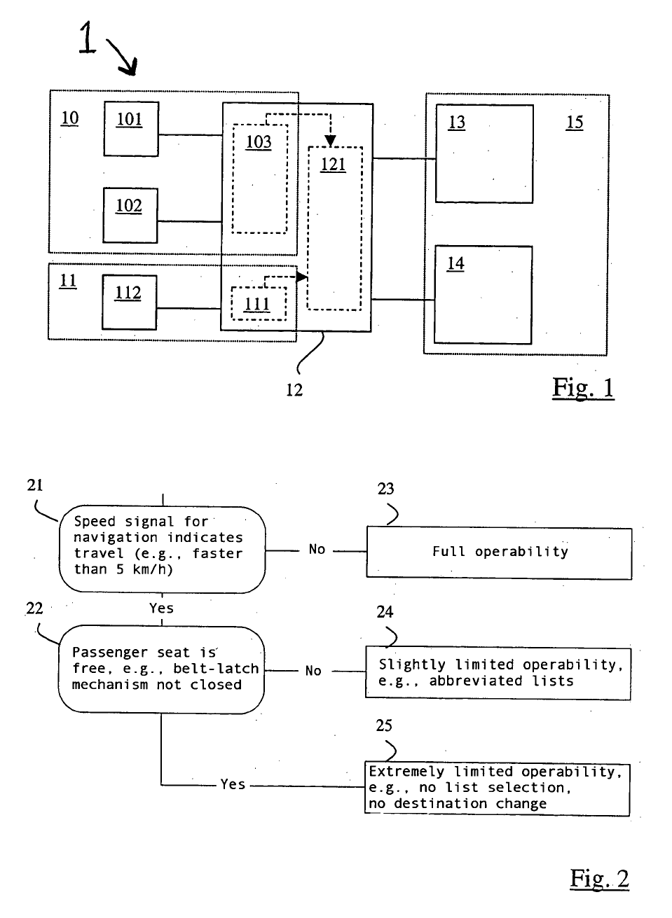

Referring to FIG. 1, the driver information system according to the present invention is elucidated in the following using primarily the example of a vehicle navigation system. However, this does not signify any restriction of the present invention to vehicle navigation systems. Rather, the present invention is also applicable to other driver information systems, such as car radios, or mobile cellular phones operated in a vehicle.

Driver information system 1 according to the present invention includes an input device 13 having operating elements, preferably tip switches and/or incremental encoders, for inputting commands and/or operating parameters into driver information system 1. In the case of a vehicle navigation system, the described operating elements are used, for example, in conjunction with a control 12 of the navigation system, for inputting a destination for a subsequent route calculation from the current location to the destination, and a subsequent route guidance. In the case of a mobile cellular phone, the operating elements are used, for example, for dialing a specific phone number of a desired telephone conversation partner or for receiving an incoming phone call.

Driver information system 1 according to the present invention also includes an output device 14, preferably designed as an optical and/or acoustic output. In the case of a vehicle navigation system, output device 14, in conjunction with the route guidance, is used for outputting driving-direction information for directing the vehicle driver in the form of spoken driving-direction information and/or in the form of directional arrows indicated on a display. Alternatively or in addition, a map display may be provided on which the calculated route or a detail of the same may be displayed to orient the vehicle driver.

In addition, output device 14 is used in conjunction with the destination input, for example, to display selectable destinations and/or a map display, on which a destination may be marked by using a cursor that is controllable by the operating elements of input device 13.

In the case of a car radio, output device 14 includes, for example, the display of the car radio on which, besides the name or the incoming frequency of an actively set transmitter, changing displays, such as the title and intrepreter of an actively transmitted piece of music or tickers, such as advertising texts, transmitted by the radio data system (RDS) are displayed.

Input device 13 and output device 14, which are each linked to control 12, together form an operator control 15 of the driver information system according to the present invention.

In addition, means 11 for generating at least one signal indicating the state of motion, in particular the travel, in contrast to standstill of the motor vehicle, are linked to control 12 of the driver information system according to the present invention. It is a question in this context, for example, of a speedometer-signal generator which indicates the current vehicle speed. In the case of a vehicle navigation system 1, means 11 may also include a GPS receiver, which evaluates positional data pertaining to the active vehicle position and derives therefrom a signal indicating the active state of motion of the vehicle.

The signals indicating the state of motion of the vehicle, e.g., of speedometer-signal generator 112, are fed to an evaluation 111, which is preferably designed as a component of the control in the form of a software routine. Evaluation 111 is designed, on the basis of the signals indicating the state of motion of the vehicle, to make a decision as to whether the vehicle is at a standstill, is driving, or is driving at a specific minimum speed.

Together, signal generator 112 and evaluation 111 form a device 11 for detecting driving of the motor vehicle.

A sensor 101, which generates a signal indicating occupancy of the passenger seat, is also connected to control 12. This sensor 101 may be designed, for example, in the form of a weight sensor, which senses a loading of the passenger seat by the weight of a passenger.

Alternatively or additionally, a signal indicating occupancy of the passenger seat may also be generated by a belt-latch mechanism 102 for the seat belt, the passenger seat being indicated as occupied when belt-latch mechanism 102 is closed, the seat belt therefore being engaged.

The signals of sensor 101, of belt-latch mechanism 102 or of both sensors are analyzed in a further evaluation 103, which is preferably designed, in turn, as a component of control 12, to detect occupancy of the passenger seat. Thus, seat-occupancy sensor 101 and/or belt-latch mechanism 102 of the passenger seat, and further evaluation 103 form a device 10 for detecting occupancy of a passenger seat of the vehicle.

One advantageous embodiment of the present invention takes into consideration that today's child safety seats are often designed to be installed on the front passenger seat next to the driver's seat, to enable small children to be safely transported in motor vehicles, such child safety seats often being secured by seat belts. In the case that such a child safety seat is installed, further evaluation 103 in accordance with the above exemplary embodiment would detect the occupancy of the passenger seat, the small child being transported there, however, not being able to take over operation of the driver information system. For that reason, this advantageous embodiment provides that a deactivation of the airbag, as provided in today's vehicles in connection with the described child safety seats, is considered in the context of the passenger-seat occupancy detection in such a way that the passenger seat may only be detected as being occupied when the airbag is not deactivated.

Another advantageous refinement of the above described embodiments is suited for vehicles equipped with additional operator controls intended for use behind the driver's seat or other passenger seats (rear seat bench, or the like) which are arranged elsewhere in the vehicle. At the present time, such installations are known above all from luxury class vehicles, in which, for example, displays are configured as additional output devices in the headrests of the front seats and are used to entertain the rear passengers. Additional input devices are routinely assigned to the displays, for example, for selecting a television program or for operating a computer game. In accordance with the present invention, these additional operator controls, thus displays and input devices, may be used for operating the driver information system. For this purpose, this embodiment also provides for detecting the occupancy of a passenger seat in the rear of the vehicle. In the event that presence of a passenger is detected both at a rear seat, as well as at the front seat, it may be provided for the front seat passenger to be assigned a higher priority for the operation of the driver information system. In the same way, however, it may also be provided for the priority to be freely adjustable.

Control 12 of the driver information system includes a third module 121, which is preferably designed, in turn, in the form of a software routine for controlling the scope of the operation or operability of the driver information system via operator control 15. For this purpose, control 12 is designed to at least partially limit an operation of the driver information system using operator control 15, thus user inputs via input device 13 and/or outputs of the driver information system to the user via output device 14, as a function of device 11 for detecting travel of the motor vehicle. Thus, control 12 implements a speed-lock function in the above sense.

The speed-lock function prevents all user inputs when driving the vehicle, by way of input device 13 of the driver information system. In addition, it may be provided for displays or acoustic outputs, which require a high level of concentration on the part of the vehicle driver in order to be properly picked up, and, thus, considerably distract the vehicle driver, to be eliminated or replaced by outputs that are easier to pick up. In a vehicle navigation system, for example, within the framework of route guidance during vehicle travel, a map display having a marked route is replaced by a simpler and more rapidly understood display of turn-off arrows and by a simple acoustic announcement of the turn-off instructions. In the same way, complex announcements, such as “in 500 m, please turn to the left into the Hildesheimer Street. Please reduce your speed, the curve is narrow” may be replaced by briefer instructions prompting action, such as “immediate left” or “next street left”.

Control 12 or third software module 121 of control 12 of the driver information system is further designed in accordance with the present invention in such a way that the control limitations that accompany the speed-lock function, thus inputs into and/or outputs of the driver information system, are at least partially canceled or suitably adapted in the case of a passenger seat recognized as occupied by occupancy-detection device 10.

This is explained in more detail based on the example of the flow chart of FIG. 2.

In step 21, control 12 checks on the basis of the speed signal, thus preferably the speedometer signal, whether the vehicle is in motion. This is ascertained, for example, on the basis of a vehicle speed of greater than 5 km/h.

If no motion of the vehicle, thus standstill, is ascertained, then the control fully releases the operation of driver information system 1 via operator control 15 (step 23).

If, on the other hand, a motion of the vehicle, thus travel, is ascertained, in a further step 22, control 12 checks on the basis of seatbelt signal 102 and/or of weight sensor 101, whether the passenger seat is occupied.

If, accordingly, the passenger seat is not occupied, control 12 activates the speed-lock function (step 24), i.e., operation of the driver information system is limited. In the present case of a vehicle navigation system 1, a selection of navigational destinations or of other adjustment parameters from the list that is displayable on display device 14, is prevented. The same holds for the inputting of a navigational destination. As described above, what remains enabled here is merely the outputting of route guidance instructions or instructions prompting action.

In the case of the car radio, for example, the display of tickers or changing displays, such as title and intrepreter displays, is prevented.

In the case of a mobile cellular phone, for example, the inputting of phone numbers via the keypad of the mobile cellular phone is prevented.

If, on the other hand, during travel of the vehicle, control 12 determines in step 22 that the passenger seat is occupied, control 12 renders possible at least a limited, but also a full operability of driver information system 1 (step 24), depending on the specific embodiment of the present invention. In this case, thus given motion of the vehicle and an occupied passenger seat, control 12 preferably enables all display possibilities and input procedures which are also possible when the vehicle is at a standstill, since they are able to be handled by the passenger who does not have to concentrate on driving the vehicle. Preferably, however, the outputs which are predominantly directed directly toward the vehicle driver who is preoccupied with the driving task, are output in a simplified and, thus, easily grasped form.

Alternatively, provision may also be made here (step 24), for example, for the acoustic driving direction instructions of the navigation system to be output in an abbreviated form that is simple to comprehend, while a detailed map display, with the driving route marked, is shown on the display of the vehicle navigation system, so that it may be understood by the passenger, who is then able to give the vehicle driver explanatory or supplemental instructions, if necessary. In addition, this alternative also provides the passenger with improved possibilities for understanding and, as the case may be, correcting the route.

In addition, it may also be provided for the extent of operability to be adjustable on an individual basis in the case of vehicle travel with an occupied passenger seat.

For the case that the vehicle driver and passenger each have separate operator controls available to them, thus their own output and/or input devices, as is the case, for instance, when there are separate entertainment systems for the rear passengers or, for instance, for the case that an extra display device is provided in the instrument cluster, in addition to the display of the driver information system configured in the center console, further control strategies may additionally be provided. Thus, in the case of a traveling vehicle and occupied passenger seat, for instance, simple directional arrows for route guidance may be indicated to the vehicle driver via the additional display in the instrument cluster, while a detailed map display with the route marked is made available to the passenger on the display in the center console or in the headrest of the front seat. In addition, an operation may be rendered possible to the passenger in that, for example, he/she may adjust any desired map detail or zoom factor via the input device, while merely the directional arrows are indicated to the driver.

The present invention may be used in all driver information systems which have a speed-lock function and which support an access to the passenger seat occupancy. When such a signal is not connected (transmission of signal is blocked), the expanded functionality for the passenger preferably does not apply.

What is claimed is:

1. A driver information system for a motor vehicle, comprising:
an operator control for operating a driver information system;
a first device for detecting travel of the vehicle;
a second device for detecting an occupancy of a passenger seat of the vehicle; and
a control for at least one of limiting and preventing an operation of the driver information system via the operator control in the case that vehicle travel is recognized, the control being adapted to at least one of at least partially cancel the limitation and prevent the operation of the driver information system.

2. The driver information system according to claim 1, wherein a seat belt for a safety belt assigned to the passenger seat emits a signal indicating the occupancy of the passenger seat.

3. The driver information system according to claim 1, wherein the passenger seat has a sensor for emitting a signal indicating the occupancy of the passenger seat.

4. The driver information system according to claim 3, wherein the sensor is a weight sensor.

5. The driver information system according to claim 1, wherein at least one of the partial cancellation of the limitation and prevention of the operation of the driver information system includes tasks that are limited compared to standstill of the vehicle via an output device of the driver information system.
